(19) United States
(12) Patent Application Publication
(10) Pub. No.: US 2002/0160145 A1
(43) Pub. Date: Oct. 31, 2002

(54) Integral structures of metal and plastic with fastening means

(76) Inventor: Michael J. Bauhoff, Troy, MI (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/085,846

(22) Filed: Feb. 27, 2002

Related U.S. Application Data
(60) Provisional application No. 60/271,935, filed on Feb. 28, 2001.

(51) Int. Cl. B32B 15/08; B32B 3/06

(52) U.S. Cl. 428/99; 428/458; 428/131; 428/119

(57) ABSTRACT

Integral structures are formed using a combination of both metal and plastic and including fastening means to secure the plastic to the metal. Several types of fastening means are disclosed. Ribbed structures in which metal is suitably joined with injection molded plastic are also contemplated herein.

### CROSS-REFERENCE TO RELATED APPLICATIONS

This application claims the benefit of U.S. Provisional Application No. 60/271,935, filed Feb. 28, 2001.

### FIELD OF THE INVENTION

The present application relates to structures made from a combination of both metal and plastic. More particularly, the present invention relates to ribbed structures in which metal is suitably joined with injection molded plastic by fastening means.

### BACKGROUND OF THE INVENTION

Material selection for the development and fabrication of structures involves any number of considerations. For example, the use of metals offers obvious benefits in strength while the use of plastics offers equally attractive benefits in moldability and lack of conductivity. However it is also well recognized that any materials also necessarily carry design limitations. For example, metals are obviously quite heavy and may not be suitable for weight-constrained applications, while plastics may not be suitable for applications requiring rigidity and durability. Researchers have long been interested in developing approaches to bring metals and plastics together into a structure or application.

U.S. Pat. No. 5,085,722 provides a composite material of a flat metal substrate with a number of apertures, with plastic material and reinforcing fibers that attach to the metal through these apertures. The composite is described as having greater fracture resistance and impact strength than the non-metallic material alone, while also limiting the transmission of temperature effects through the composite versus what would be experienced if only metal were used.

U.S. Pat. No, 4,569,865 discloses light weight, corrosion resistant automotive bumpers including thin metal outer shells bonded to rigid but resilient foamed plastic cores. An intermediate primer layer preferably of ethylene copolymer is used in the bonding process. The metal is preferably stainless steel or aluminum. Because no bolts are used, the metal layer offers superior corrosion resistance and a smooth appearance.

U.S. Pat. No. 4,682,809 describes a body construction for lightweight passenger vehicles including an elongated shell of highly impact resistant plastics material. A metal chassis is secured to this shell to form an integrated composite structure. This construction offers improved rigidity for body constructions of battery-powered vehicles.

While each of the above approaches may be of interest in their respective selected applications, they are not readily adaptable to a wide range of uses. For example, each requires reinforcing fibers or foamed materials or is limited in scope to large shell-type applications. These and other teachings are generally representative of the techniques and constraints evidenced to date in developing structures of this variety.

There is a need therefore for an integral structure of metal and plastic, in which the plastic is firmly secured to the metal and can nevertheless be injection molded using conventional molding techniques and without requiring special processing.

An object of the instant invention is to provide useful integral structures of metal and plastic in which the materials are effectively joined to form rigid and durable assemblies. A further object of the instant invention is to provide such structures whereby the designer can incorporate plastic ribs to provide further support as may be required for particular applications. A feature of the instant invention resides in the variety of shapes that can be fashioned using the approaches described herein, and with them the number of applications for which this invention is suitable. Another feature of the instant invention is the incorporation of any of a variety of fastening means to provide a secure fit of metal to plastic without deleteriously affecting the performance or appearance of the integral structure itself. An advantage of the instant invention is the range of materials that may be selected and suitable for forming integral structures therefrom.

These and other objects, features, and advantages will become better understood upon having reference to the following description of the invention.

### SUMMARY OF THE INVENTION

An integral structure is disclosed comprising a metal surface and a plastic surface, and further wherein these surfaces are joined by one of more fastening means. Each fastening means comprises a head portion and a neck portion joined thereto, such that an undercut is formed.

### BRIEF DESCRIPTION OF THE DRAWINGS

The invention will be better illustrated upon having reference to the drawings herein and as follows:

FIG. 1 is a perspective view in partial transparency of a structural component of the present invention and having metal and plastic members and fastening means; and

FIG. 2 is a side view of a structural component of the present invention and depicting several embodiments (A) through (F) of the fastening means of the present invention.

### DETAILED DESCRIPTION OF THE INVENTION

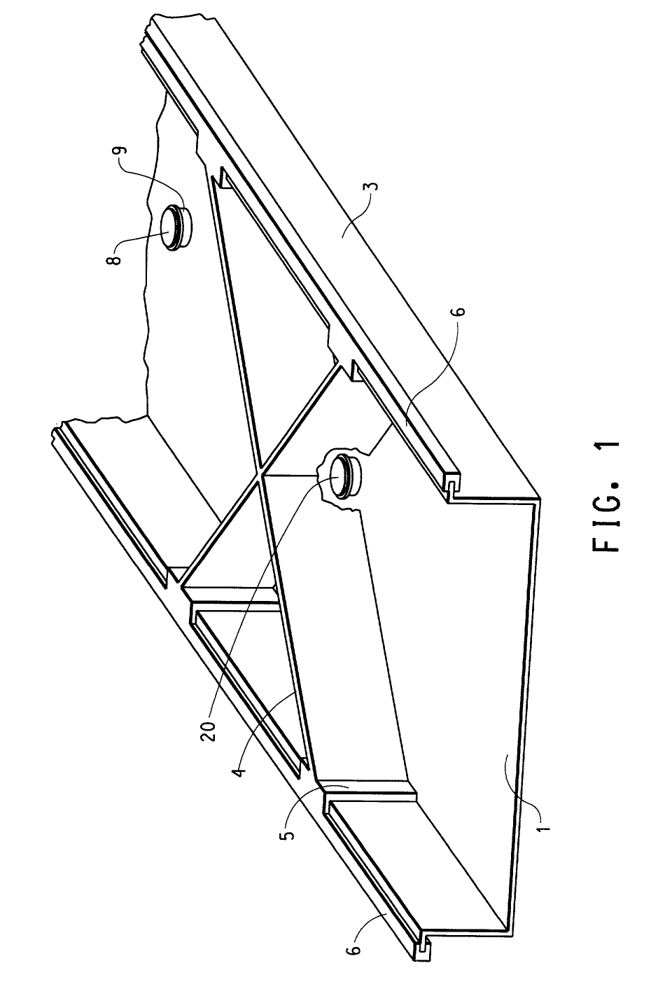

Having reference to FIG. 1, there is shown generally an integral structure 10 of metal with molded plastic. In this illustration the main member 1 and the support members 3 of the structural component are metal. The support members 3 attach to (or are a part of) the main member 1 and (as shown) extend generally perpendicular to the main member 1, in effect forming “side walls”. Ribs 4 formed from plastic as shown connect the support members 3 to each other and provide additional rigidity to the integral structure as warranted. One skilled in the art will selectively introduce the ribs 4 as one of many possible approaches to providing a more rigid assembly. Rib supports 5 are positioned between the ribs 4 and the support members 3. Moreover, the rib supports 5 connect with lip 6 which serves to lock the ribs 4 with the main member 1. These rib supports 5 and lip 6 are made of plastic.

One or more head assemblies generally shown at 20 secure the plastic (as shown, formed as ribs 4) to the metal (as shown, formed as the main member 1). These head assemblies comprise a head portion 8 and a stem portion 9. In FIG. 1, the head portion 8 and stem portion 9 form a “mushroom” configuration, with the head portion 8 being wider than the stem portion 9 as viewed from the side. This is sometimes known in the field as forming an “undercut”, with the stem portion 9 undersized relative to the head portion 8. As plastic is molded over the head assemblies, the resulting ribs 4 are “locked” into position to the main member 1 and/or support members 3.

There are no restrictions on the exact configuration of the head assembly including head portion 8 and stem portion 9, so long as an undercut or equivalent design feature is represented in the assembly. Multiple undercuts may be present on head assemblies. One skilled in the art will select a suitable design to conform to the dimensional constraints of the integral structure 10 and at the same time meet the functional specifications required of the structure itself.

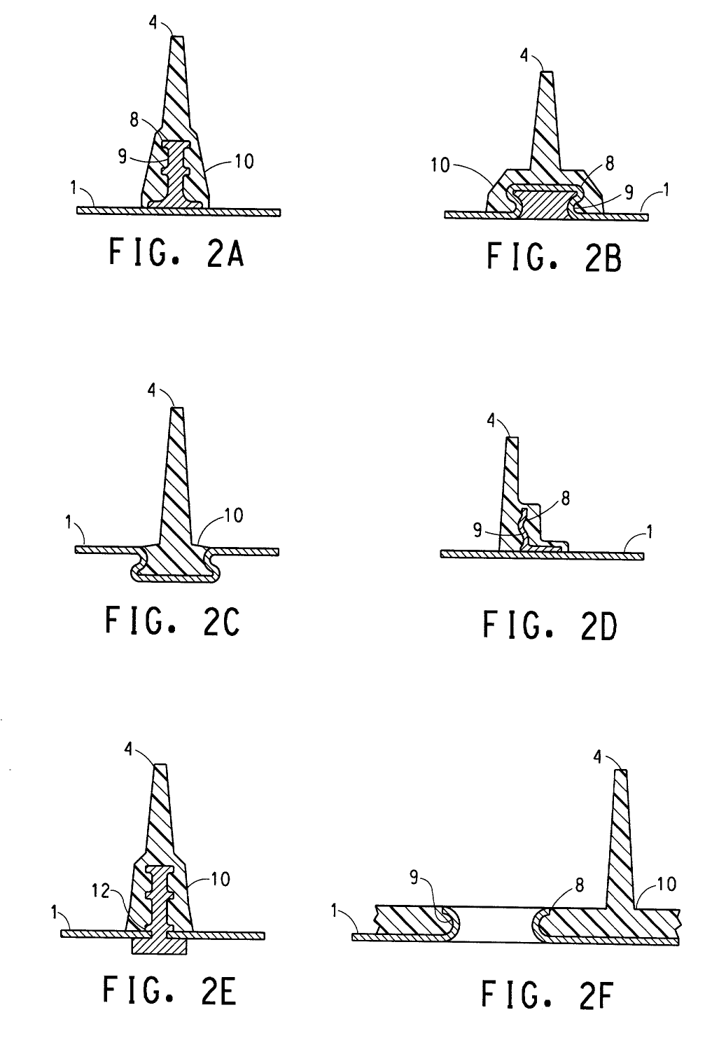

For instance, a number of designs of the head assembly are shown in FIG. 2. FIG. 2A illustrates in cross section one possible “mushroom” configuration as earlier described. The base portion 10 of the rib 4 contacts the head assembly, resulting in a secured fit. In practice the head assembly of FIG. 2A is spot welded onto the main member 1 (or wherever else within the structure a head assembly is to be incorporated into the design). This head assembly may also contain one or more holes through either the head portion 8 or the stem portion 9 and through which polymer flows, and the use of such optional features enhances the metal to plastic bond.

FIGS. 2B and 2C represent alternative designs for the “mushroom” configuration, in which the head assembly is actually formed from the main member 1 or other surface. In FIG. 2B the metal is deformed from the general plane of the metal towards the plastic portion of the integral structure to be secured. (As shown, polymer is also deposited onto the backside of main member 1). In FIG. 2C the metal is deformed away from such plastic portions. In either event, the base portion 10 of the rib 4 is molded such that polymer is deposited around the head assembly (in 2B) or within the cavity formed by the head assembly (in 2C) to provide a secured fit.

FIG. 2D is another variation of a head assembly contemplated as within the scope of the present invention. While in appearance it does not resemble a mushroom, nevertheless it has a defined head portion 8 and a defined neck portion 9, and both again with the requisite positioning and characteristics to provide a secured fit of polymer to metal. In this case, the head assembly resembles a metal “tab” with a dimple thereon. This assembly may be spot welded to a suitable surface such as the main member 1, and the rib 4 is molded over the “tab” and dimple.

FIG. 2E is yet another variation of a head assembly. It is similar to the spot weld stud of FIG. 2A but differs in that the headed stud is fixed to the main member 1 by insertion into aperture 12. The stud can be formed from metal or plastic. A metal stud may be secured to the main member 1 using traditional metal joining or forming methods. A plastic stud is secured to the main member by interference fit or common undercut details molded integral to the stud allowing a simple snap fit assembly. The base portion 10 of the rib 4 is molded such that polymer is deposited around the head assembly as in case 2A providing a secured fit of the plastic to main member 1. The head assemblies of FIG. 2E may either be spot welded onto a surface where support is desirable, or formed from such a surface through conventional metal stamping operations.

FIG. 2F is still another variation of a head assembly suitable for incorporation into the integral structures of the present invention. Here, the head assembly is a metal extrusion and is positioned on either side of the rib 4. This extrusion is formed such that in profile there is a head portion 8 and a neck portion 9. The ribs 4 again include base portion 10 and when joined with the head assemblies form a secured fit.

Materials suitable for practice in conjunction with the structure of the invention are limited only by the intended shape and function of the structure itself. For example, metals useful with this invention may be of a more conventional variety (e,g steel, aluminum, nickel and the like) or may be selected for their properties that benefit specialized applications (eg titanium, brass and the like). Likewise, plastics useful with this invention include not only polyamides (such as ZYTEL® nylon resins available from E.I. DuPont de Nemours & Co.) but also polyesters, liquid crystalline polymers, and the like. Polymers which may be injection molded are particularly preferred.

The structures herein may be produced using conventional metal working and plastic molding techniques, all as will be readily appreciated and known by those having ordinary skill in the art. Metal stamping operations are noted as of particular interest, coupled with the injection molding of polymer resin onto the formed metal surface to develop the metal/plastic structure.

A wide range of uses is contemplated for structures as disclosed herein. One area of particular interest is in module assemblies such as those of interest to automotive applications. A module assembly is a self-contained assembly of electronic and mechanical components. Often these modules require intricate backbone structures which can benefit from the technology of combining both plastic molding for function and detail with metals for strength, stiffness and dimensional control. For example, and owing to the balance of metal with plastic in a way that forms a rigid, durable assembly capable of supporting numerous elements, such structures provide a platform upon which one can secure a number of automobile parts. One such platform is known as a “front end module”, and provides an intricate molding for the attachment of headlight assemblies, shrouds, wiring harnesses, and the like.

It is readily apparent to those having skill in the art that a number of variations in design and materials selection are within the scope and purview of this invention. Such variations are considered as within the scope thereof.

1. An integral structure comprising a metal surface and a plastic surface, said surfaces joined by one or more fastening means.

2. The integral structure of claim 1 wherein said fastening means comprises a head portion and a neck portion joined thereto forming an undercut.

3. The integral structure of claim 1 further comprising plastic ribs interconnected along said metal surface.

4. The integral structure of claim 3 wherein said plastic surface and plastic ribs are selected from the group consisting of polyamides, polyesters, and liquid crystalline polymers.

5. The integral structure of claim 2 wherein said fastening means further comprises one or more apertures formed therethrough.

6. An article made from the integral structure of claim 1.

7. A front end module made from the integral structure of claim 1.
